(19) United States
(12) Patent Application Publication
(10) Pub. No.: US 2026/0264611 A1
(43) Pub. Date: Sep. 10, 2026

(54) SYSTEM AND METHOD FOR SELECTIVE CONTROL OF DIMMABLE ELECTRO-OPTIC ELEMENTS BASED ON DRIVER, CAMERA, AND ELEMENT POSITIONING

(71) Applicant: Gentex Corporation, Zeeland, MI (US)

(72) Inventors: Keith W. Bigoness, Grand Rapids, MI (US); Andrew D. Weller, Holland, MI (US); Benjamin B. Hilldore, Holland, MI (US)

(21) Appl. No.: 19/165,674

(22) PCT Filed: Feb. 19, 2025
(86) PCT No.: PCT/IB2025/051789

§ 371 Date: Sep. 16, 2025

Related U.S. Application Data
(60) Provisional application No. 63/556,438, filed on Feb. 22, 2024.

(51) Int. Cl. B60R 1/08; B60R 1/12; G02F 1/133; G02F 1/163

(52) U.S. Cl. CPC B60R 1/088; G02F 1/133; G02F 1/163; B60R 1/1207; B60R 2001/1223; B60R 2001/1253

(57) ABSTRACT

A rearview assembly for a vehicle is provided including: an electro-optic mirror element disposed to provide a driver of the vehicle with a first field of view rearward relative to the vehicle, the electro-optic mirror element having variable reflectivity; an image sensor associated with the vehicle to capture images of a rearward scene within a second field of view; a position sensor configured to sense positioning of the electro-optic mirror element; and a controller communicatively connected to the electro-optic mirror element, the image sensor, and the position sensor. The controller is configured to: determine positioning of the electro-optic mirror element; identify one or more light sources in images captured by the image sensor; estimate a region in the images corresponding to the first field of view; and vary the reflectivity of the electro-optic mirror element based on whether the identified light sources are within the estimated region.

### CROSS-REFERENCE TO RELATED APPLICATION

This application claims priority to and the benefit under 35 U.S.C. § 119(e) of U.S. Provisional Patent Application No. 63/556,438, filed on Feb. 22, 2024, entitled “SYSTEM AND METHOD FOR SELECTIVE CONTROL OF DIMMABLE ELECTRO-OPTIC ELEMENTS BASED ON DRIVER, CAMERA, AND ELEMENT POSITIONING,” by Keith W. Bigoness et al., the entire disclosure of which is incorporated herein by reference.

### TECHNOLOGICAL FIELD

The present invention relates to a system and method for controlling dimmable electro-optic elements of a vehicle and, more particularly, relates to a system and method for controlling the dimming of electro-optic elements of a vehicle based, in part, on captured images.

### SUMMARY OF THE INVENTION

According to one aspect of the invention, a dimmable optical element is provided for a vehicle. The dimmable optical element comprising: an electro-optic element disposed to provide a driver of the vehicle with a first field of view, the electro-optic element having variable dimming; an image sensor associated with the vehicle to capture images of a scene within a second field of view; and a controller communicatively connected to the electro-optic element and the image sensor. The controller configured to: identify one or more light sources in one or more images captured by the image sensor; determine the position of the driver; estimate a region in the one or more images corresponding to the first field of view based, at least in part, on the position of the driver; determine whether the identified one or more light sources are within the estimated region; and vary the dimming of the electro-optic element based, at least in part, on the determination as to whether the identified one or more light sources are within the estimated region.

It is another aspect of the present disclosure to provide a dimmable optical element for a vehicle. The dimmable optical element comprises: an electro-optic element disposed to provide a driver of the vehicle with a first field of view, the electro-optic element having variable dimming; an image sensor associated with the vehicle to capture images of a scene within a second field of view; a position sensor configured to sense positioning of the electro-optic element; and a controller communicatively connected to the electro-optic element, the image sensor, and the position sensor. The controller configured to: determine positioning of the electro-optic element; identify one or more light sources in one or more images captured by the image sensor; estimate a region in the one or more images corresponding to the first field of view based, at least in part, on the position of the electro-optic element; determine whether the identified one or more light sources are within the estimated region; and vary the dimming of the electro-optic element based, at least in part, on the determination as to whether the identified one or more light sources are within the estimated region.

It is another aspect of the present disclosure to provide a rearview mirror assembly for a vehicle, the rearview mirror assembly comprising: an electro-optic mirror element disposed to provide a driver of the vehicle with a first field of view rearward relative to the vehicle, the electro-optic mirror element having variable reflectivity; an image sensor associated with the vehicle to capture images of a rearward scene within a second field of view; a position sensor configured to sense positioning of the electro-optic mirror element; and a controller communicatively connected to the electro-optic mirror element, the image sensor, and the position sensor. The controller is configured to: determine positioning of the electro-optic mirror element; identify one or more light sources in one or more images captured by the image sensor; estimate a region in the one or more images corresponding to the first field of view; determine whether the identified one or more light sources are within the estimated region; and vary the reflectivity of the electro-optic mirror element based, at least in part, on the determination as to whether the identified one or more light sources are within the estimated region.

According to another aspect of the invention, a rearview mirror system is provided for a vehicle, the rearview mirror system comprising: an interior rearview mirror assembly comprising: a first electro-optic mirror element; at least one outside rearview mirror assembly; an image sensor; and a controller. The interior rearview mirror assembly comprising: a first electro-optic mirror element disposed to provide a driver of the vehicle with a first field of view rearward relative to the vehicle, the first electro-optic mirror element having variable reflectivity; and a first position sensor configured to sense positioning of the first electro-optic mirror element. The at least one outside rearview mirror assembly comprising: a second electro-optic mirror element disposed to provide the driver of the vehicle with a second field of view rearward relative to the vehicle, the second electro-optic mirror element having variable reflectivity; and a second position sensor configured to sense positioning of the second electro-optic mirror element. The image sensor is associated with the vehicle to capture images of a rearward scene within a third field of view. The controller is communicatively connected to the first and second electro-optic mirror elements, the image sensor, and the first and second position sensors, the controller configured to: determine positioning of the first and second electro-optic mirror elements; identify one or more light sources in one or more images captured by the image sensor; estimate a first region in the one or more images corresponding to the first field of view; estimate a second region in the one or more images corresponding to the second field of view; determine whether the identified one or more light sources are within the estimated first region in the one or more images; vary the reflectivity of the first electro-optic mirror element based, at least in part, on the determination as to whether the identified one or more light sources are within the estimated first region in the one or more images; determine whether the identified one or more light sources are within the estimated second region in the one or more images; and vary the reflectivity of the second electro-optic mirror element based, at least in part, on the determination as to whether the identified one or more light sources are within the estimated second region in the one or more images.

According to another aspect of the invention, a method is provided for varying reflectance of an electro-optic mirror of a vehicle using a controller and an image sensor, the electro-optic mirror provides a first field of view to the driver of the vehicle. The method includes the steps of: determining positioning of the electro-optic mirror; identifying one or more light sources in one or more images captured by the image sensor; estimating a region in the one or more images corresponding to the first field of view; determining whether the identified one or more light sources are within the estimated region; and varying the reflectivity of the electro-optic mirror based, at least in part, on the determination as to whether the identified one or more light sources are within the estimated region.

According to another aspect of the invention, a method is provided for varying reflectance of electro-optic mirrors of a rearview system including an inside rearview mirror assembly having a first electro-optic mirror providing a first field of view to a driver of the vehicle and a driver side outside rearview mirror assembly having a second electro-optic mirror providing a second field of view to the driver, the method includes the steps of: determining positioning of the first and second electro-optic mirrors; identifying one or more light sources in one or more images captured by an image sensor; estimating first and second regions in the one or more images corresponding to the respective first and second fields of view; determining whether the identified one or more light sources are within the estimated first region; varying the reflectivity of the first electro-optic mirror based, at least in part, on the determination as to whether the identified one or more light sources are within the estimated first region; determining whether the identified one or more light sources are within the estimated second region; varying the reflectivity of the second electro-optic mirror based, at least in part, on the determination as to whether the identified one or more light sources are within the estimated second region.

According to another aspect of the invention, a method is provided for varying reflectance of electro-optic mirror elements of a rearview system including an inside rearview mirror assembly having a first electro-optic mirror element providing a first field of view to a driver of the vehicle, a driver side outside rearview mirror assembly having a second electro-optic mirror element providing a second field of view to the driver, and a passenger side outside rearview mirror assembly having a third electro-optic mirror element providing a third field of view to the driver, the method includes the steps of: determining positioning of the first, second, and third electro-optic mirror elements; identifying one or more light sources in one or more images captured by an image sensor; estimating first, second, and third regions in the one or more images corresponding to the respective first, second, and third fields of view; determining whether the identified one or more light sources are within the estimated first region; varying the reflectivity of the first electro-optic mirror element based, at least in part, on the determination as to whether the identified one or more light sources are within the estimated first region; determining whether the identified one or more light sources are within the estimated second region; varying the reflectivity of the second electro-optic mirror element based, at least in part, on the determination as to whether the identified one or more light sources are within the estimated second region; determining whether the identified one or more light sources are within the estimated third region; and varying the reflectivity of the third electro-optic mirror element based, at least in part, on the determination as to whether the identified one or more light sources are within the estimated third region. The process is then repeated to detect movement of the mirror elements and to continue to identify light sources and their relative positions.

These and other features, advantages, and objects of the present device will be further understood and appreciated by those skilled in the art upon studying the following specification, claims, and appended drawings.

### BRIEF DESCRIPTION OF THE DRAWINGS

The embodiments will now be described with reference to the following drawings, in which:

FIG. 1 is a plan view of a vehicle having a rearview mirror system;

FIG. 2 is an electrical circuit diagram in block form illustrating the rearview system implemented in the vehicle shown in FIG. 1;

FIG. 3 is an example of a field of view of an image sensor of the rearview mirror system shown in FIGS. 1 and 2;

FIG. 4 is a projected view of an interior rearview mirror assembly of the rearview system shown in FIGS. 1 and 2;

FIG. 5 is a flow chart of a method that may be performed using the circuit shown in FIG. 2;

FIG. 6 is a flow chart of another method that may be performed using the circuit shown in FIG. 2; and

FIG. 7 is a flow chart of another method that may be performed using the circuit shown in FIG. 2.

The components in the figures are not necessarily to scale, emphasis instead being placed upon illustrating the principles described herein.

### DETAILED DESCRIPTION OF EMBODIMENTS

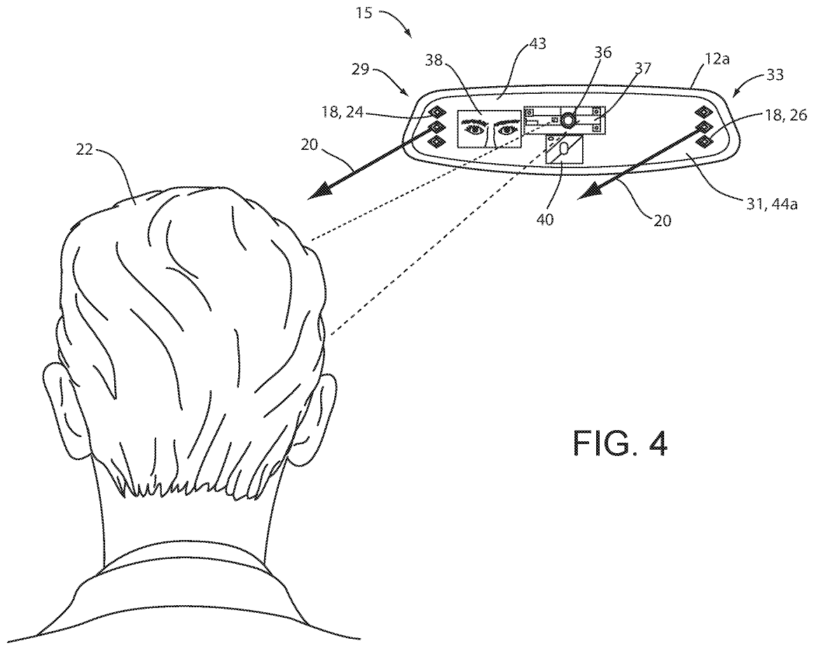

For purposes of description herein, the terms “upper,” “lower,” “right,” “left,” “rear,” “front,” “vertical,” “horizontal,” and derivatives thereof shall relate to the interior rearview assembly as oriented in FIG. 4. Unless stated otherwise, the term “front” shall refer to the surface of the element closer to an intended viewer of the rearview mirror assembly, and the term “rear” shall refer to the surface of the element further from the intended viewer of the rearview mirror assembly. However, it is to be understood that the invention may assume various alternative orientations, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a.” does not, without more constraints, preclude the existence of additional identical elements in the process, method, article, or apparatus that comprises the element.

As defined herein, “approximately” and “about,” when used in reference to angles, proportions, and the like, may, in some embodiments, mean within plus or minus ten percent of the stated value. In other embodiments, “approximately” and “about,” when used in reference to angles, proportions, and the like, may mean within plus or minus five percent of the stated value. In further embodiments, “approximately” and “about,” when used in reference to angles, proportions, and the like, may mean within plus or minus three percent of the stated value. In yet other embodiments, “approximately” and “about,” when used with reference to angles, proportions, and the like, may mean within plus or minus one percent of the stated value.

Rearview systems for vehicles are known that detect excessive glare light from headlights of following vehicles and adjust the reflectivity of inside and outside electro-optic mirror elements to reduce the glare reflected towards the eyes of the driver. Typically, a dedicated discrete light sensor is used to sense the glare light from the rear of the vehicle. With such a discrete light sensor, the location of the headlights of following vehicles within a rearward scene cannot be determined so the reflectivity of the entire viewing area of each electro-optic mirror is reduced. Although this ensures that excessive glare is not reflected to the driver, it unnecessarily reduces reflectance of areas of the rearward scene that are not producing glare and thus makes details in those areas harder to perceive at nighttime.

Commonly-assigned U.S. Pat. No. 11,027,657 discloses a rearview system that uses a rearview camera as a glare sensor thereby eliminating the need for a dedicated discrete glare light sensor. This patent further discloses that the images from the rearview camera may be analyzed to determine a region of the rearward scene in which the headlamps are detected and then to independently control the rearview mirrors so that only those mirrors that reflect that region of the rearward scene have their reflectivity decreased. Moreover, if the region is one that is not reflected by any of the mirrors, the reflectivity of the mirrors is not decreased. Also, by using the image sensor, movement of the headlights from one region to another may be anticipated and the reflectivity of the mirrors may be controlled accordingly. The entire disclosure of U.S. Pat. No. 11,027,657 is incorporated herein by reference.

The present disclosure relates to an improvement in the rearview system disclosed in U.S. Pat. No. 11,027,657 by using knowledge of the spatial positioning of the image sensor, mirror elements and the driver to selectively adjust the reflectivity of one or more mirror elements to increase user comfort and maintain maximum rearward visibility. By more selectively adjusting reflectivity of the mirror elements, power efficiency of the system may be increased.

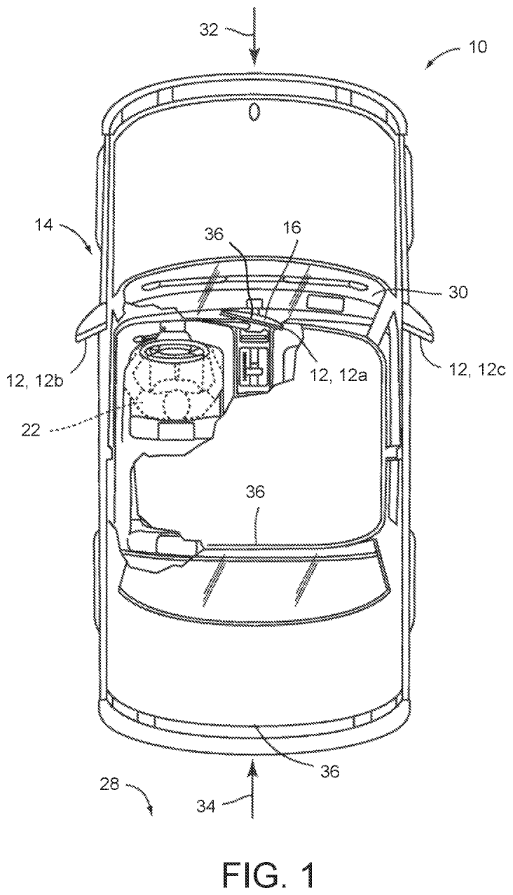

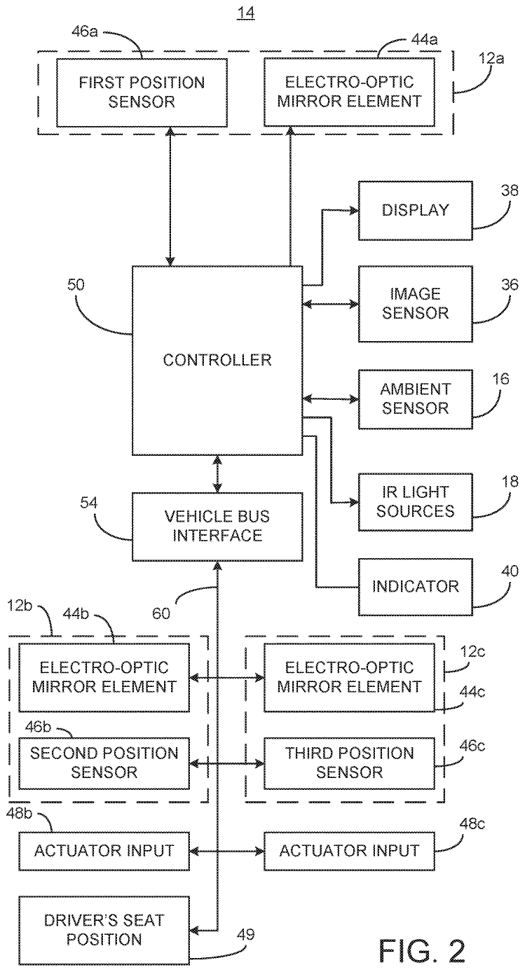

FIG. 1 illustrates a vehicle 10 with a rearview system 14. Rearview system 14 includes one or more variable reflectance mirror assemblies 12, a rearview image sensor 36, and a controller 50 (see FIG. 2).

Variable reflectance mirror assemblies 12 may include any mirror operable to vary the degree to which light is reflected. The reflectance of a mirror is the ratio of light reflected therefrom with respect to the light incident thereto. Further, variable reflectance mirror assemblies 12 may each be operable to provide a driver 22 a view of a rearward scene 28 to the rear of the vehicle 10. Variable reflectance mirror assemblies 12 may be located interior or exterior vehicle 10. For example, variable reflectance mirror assembly 12 may be an inside rearview mirror assembly 12a or an outside rearview mirror assembly such as a driver side rearview mirror assembly 12b or a passenger side rearview mirror assembly 12c.

As shown in FIG. 2, inside rearview mirror assembly 12a may include an electro-optic mirror element 44a and a first position sensor 46a for sensing the position of the electro-optic mirror element 44a. The position includes the vertical and horizontal angles of the mirror element 44a.

As also shown in FIG. 2, each outside rearview mirror assembly 12b, 12c may include an electro-optic mirror element 44b,44c and a position sensor 46b,46c that senses the position of the corresponding electro-optic mirror element 44b,44c. The driver side rearview mirror assembly 12b may thus have a second position actuator 46b and the passenger side rearview mirror assembly 12c may have a third position sensor 46c. The position sensors 46b and 46c may be part of a corresponding actuator that changes the position of the corresponding mirror element 44b,44c. The driver side rearview mirror assembly 12b and the passenger side rearview mirror assembly 12c may be associated with an actuator input mechanism 48b,48c that allows the user to control the corresponding actuator so as to position the electro-optic mirror element 44b,44c at appropriate vertical and horizontal angles so as to view the desired portion of the rearward scene 28. The inside rearview mirror assembly 12a may also include an actuator and associated actuator input mechanism.

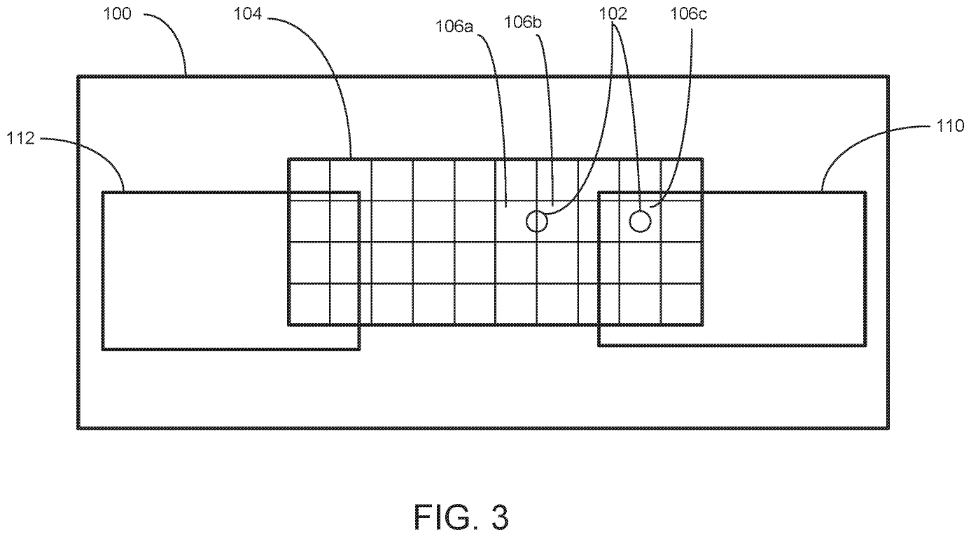

FIG. 3 shows an example of an image 100 captured by the image sensor 36 at nighttime where one or more light sources 102 are present.

The controller 50 may be communicatively connected to the image sensor 36, at least one of the electro-optic mirror elements 44a,44b,44c, and at least one of the first, second and third position sensors 46a,46b,46c. In the case of the rearview mirror system 14 including the inside rearview mirror assembly 12a and having a first electro-optic mirror element 44a that provides the driver 22 with a first field of view of the rearward scene 28, the controller 50 may be configured to: determine a position of the electro-optic mirror element 44a; identify one or more light sources 102 in one or more images 100 captured by the image sensor 36; estimate a region 104 in the one or more images 100 corresponding to the first field of view; determine whether the identified one or more light sources 102 are within the estimated region 104; and vary the reflectivity of the electro-optic mirror element 44a based, at least in part, on the determination as to whether the identified one or more light sources 102 are within the estimated region 104.

The light sources 102 may be identified from pixels of the image sensor 36 that exceed a threshold. The threshold may vary depending on the average light levels sensed by the image sensor 36.

The electro-optic mirror element 44a may include an active-matrix electrode such that portions of the electro-optic mirror element 44a may be individually controlled to have variable reflectivity. The controller 50 maps the corresponding locations 106a, 106b,106c, etc. of the positions of the electro-optic mirror element 44a to the region of the one or more images 100 and determines within which locations 106a, 106b, 106c the identified one or more light sources 102 are identified and varies the reflectivity of those portions of the electro-optic mirror element 44a corresponding to the determined locations 106a,106b,106c without varying the reflectivity of any other portions of the electro-optic mirror element 44a not corresponding to the determined locations 106a,106b,106c.

The controller 50 may determine the position of the driver and estimate the region 104 of the one or more images 100 based, at least in part, on the position of the driver. The controller 50 may determine the position of the driver by any one or more of driver's seat position, in-cabin sensing, or assumptions based on nominal conditions. The driver's seat position may be determined using an input of the driver's seat position 49 generated by either the seat position controls or one or more sensors. In-cabin sensing may be performed by the image sensor 36 or another sensor such as another image sensor, a proximity sensor, an ultrasonic sensor, or the like.

The controller 50 may determine the position of the image sensor 36 and estimate the region 104 of the one or more images 100 based, at least in part, on the position of the image sensor 36. The position of the image sensor 36 could also be determined via calibration and/or using a priori knowledge of the installation location of the image sensor 36. The controller 50 may determine the position of the electro-optic mirror element 44a from input from the first position sensor 46a.

In the case of the rearview mirror system 14 including an inside rearview mirror assembly 12a and at least one outside rearview mirror assembly 12b,12c, the inside rearview mirror assembly 12a may include a first electro-optic mirror element 44a disposed to provide a driver 22 of the vehicle 10 with a first field of view rearward relative to the vehicle 10, and a first position sensor 46a configured to sense positioning of the first electro-optic mirror element 44a. The at least one outside rearview mirror assembly 12b,12c may include a second electro-optic mirror element 44b,44c disposed to provide the driver 22 of the vehicle 10 with a second field of view rearward relative to the vehicle 10, and a second position sensor 46b,46c configured to sense positioning of the second electro-optic mirror element 44b,44c. The controller 50 is communicatively connected to the first and second electro-optic mirror elements 44a,44b,44c, the image sensor 36, and the first and second position sensors 46a,46b,46c. The controller 50 may be configured to: determine positioning of the first and second electro-optic mirror elements 44a,44b,44c; identify one or more light sources 102 in one or more images 100 captured by the image sensor 36; estimate a first region 104 in the one or more images 100 corresponding to the first field of view; estimate a second region 110,112 in the one or more images 100 corresponding to the second field of view; determine whether the identified one or more light sources 102 are within the estimated first region 104 in the one or more images 100; vary the reflectivity of the first electro-optic mirror element 44a based, at least in part, on the determination as to whether the identified one or more light sources 102 are within the estimated first region 104 in the one or more images 100; determine whether the identified one or more light sources 102 are within the estimated second region 110,112 in the one or more images 100; and vary the reflectivity of the second electro-optic mirror element 44b,44c based, at least in part, on the determination as to whether the identified one or more light sources 102 are within the estimated second region 110,112 in the one or more images 100. If the one or more light sources 102 are not within the estimated second region 110,112, the controller 50 will not decrease the reflectivity of the mirror element 44b,44c. Similarly, if the one or more light sources 102 are not within the estimated first region 104, the controller 50 will not decrease the reflectivity of the mirror element 44a. In the example shown in FIG. 3, one or more light sources 102 are in regions 104 and 110. The controller 50 may thus respond by decreasing the reflectance of the driver side electro-optic mirror element 44b and of the inside electro-optic mirror element 44a while not decreasing the reflectance of the passenger side electro-optic mirror element 44c.

When the at least one outside rearview mirror assembly comprises a driver side outside rearview mirror assembly 12b and a passenger side outside rearview mirror assembly 12c, the driver side outside rearview mirror assembly includes the second electro-optic mirror element 44b and the second position sensor 46b, and the passenger side outside rearview mirror assembly 12c includes a third electro-optic mirror element 44c disposed to provide the driver of the vehicle with a third field of view rearward relative to the vehicle, and a third position sensor 46c configured to sense positioning of the third electro-optic mirror element 44c. The controller 50 is communicatively connected to the third electro-optic mirror element 44c and the third position sensor 46c and is further configured to: determine positioning of the third electro-optic mirror element 44c; estimate a third region 112 in the one or more images 100 corresponding to the third field of view; determine whether the identified one or more light sources 102 are within the estimated third region 112 in the one or more images 100; and vary the reflectivity of the third electro-optic mirror element 44c based, at least in part, on the determination as to whether the identified one or more light sources 102 are within the estimated third region 112 in the one or more images 100. If no light source 102 is determined to be within the third region 112, the controller 50 does not decrease the reflectance of the third electro-optic mirror element 44c. Similarly, the controller 50 is configured to: determine positioning of the second electro-optic mirror element 44b; estimate a second region 110 in the one or more images 100 corresponding to the second field of view; determine whether the identified one or more light sources 102 are within the estimated second region 110 in the one or more images 100; and vary the reflectivity of the second electro-optic mirror element 44b based, at least in part, on the determination as to whether the identified one or more light sources 102 are within the estimated second region 110 in the one or more images 100. If no light source 102 is determined to be within the second region 110, the controller 50 does not decrease the reflectance of the second electro-optic mirror element 44b.

The positions of the electro-optic mirror elements 44a,44b,44c may include the vertical and horizontal angles of these elements.

Although FIG. 3 only shows the first region 104 is divided into various locations 106a,106b,106c, etc. corresponding to an inside electro-optic mirror element 44a with an active matrix, the outside mirror elements 44b and 44c may also have active matrixes and the second and third regions 110 and 112 may also be divided into separate locations so as to independently and selectively vary the reflectance of portions of the mirror elements 44b and 44c without varying other portions.

Rearview image sensor 36 may be any device operable to capture image data, comprising a pixel array. The image sensor 36 may correspond to, for example, a digital charge-coupled device (CCD) or complementary metal-oxide-semiconductor (CMOS) active pixel sensor, although not be limited to these exemplary devices. The rearview image sensor 36 is positioned and oriented such that it may capture image data corresponding to at least part of rearward scene 28. For example, rearview image sensor 36 may be located on a vehicle 10's interior rearview mirror assembly 12a (as shown in FIG. 3), headliner, rear window, rear bumper, or hatch/rear door/trunk lid (as shown in FIG. 1). The pixel array comprises a plurality of pixels in the form of light sensitive elements configured to measure light received through a lens or aperture. Each pixel of the pixel array may correspond to a photo sensor, an array of photo sensors, or any grouping of sensors configured to capture light. Each of the photo sensors may be operable to measure a value corresponding to a brightness or intensity of light. Rearview image sensor 36 may have a high dynamic range. The image sensor 36 may also be a thermal camera.

Examples of rearview image sensors 36 configured to operate as high dynamic range image sensors are disclosed in U.S. Pat. No. 8,289,430 entitled “HIGH DYNAMIC RANGE IMAGING DEVICE,” filed Dec. 6, 2007, by Jon H. Bechtel et al.; U.S. Pat. No. 8,305,471 entitled “HIGH DYNAMIC RANGE IMAGING DEVICE,” filed Apr. 25, 2008, by Jon H. Bechtel et al.; U.S. Pat. No. 8,378,284 entitled “IMAGING DEVICE,” filed Jan. 28, 2009, by Daniel Van Blerkom et al.; U.S. Pat. No. 8,144,223 entitled “IMAGING DEVICE,” filed Jan. 28, 2009, by Daniel Van Blerkom et al.; U.S. Pat. No. 8,629,927 entitled “IMAGING DEVICE,” filed Apr. 9, 2008, by Jon H. Bechtel et al.; U.S. Pat. No. 8,587,706 entitled “IMAGING DEVICE,” filed Jun. 11, 2008, by Jon H. Bechtel; and U.S. Pat. No. 9,041,838 entitled “HIGH DYNAMIC RANGE IMAGER SYSTEM,” filed Feb. 14, 2013, by Jon H. Bechtel, all of which are hereby incorporated herein by reference in their entirety.

Controller 50 may be any device operable to analyze image data from rearview image sensor 36 to determine the presence, intensity, or relative location of glare light 34. For example, controller 50 may be one or more processors, a multicore processor, or any combination of processors, circuits, and peripheral processing devices. Additionally, controller 50 may comprise a memory operable to store a pixel analysis algorithm. Further, controller 50 may be operable to adjust a reflectance, brightness, transmittance, or other display characteristic of one or more variable reflectance mirror elements 12a,12b, 12c. Accordingly, controller 50 is communicatively connected to one or more variable reflectance mirror elements 12a, 12b,12c and rearview image sensor 36.

In some embodiments, rearview system 14 may include a forward ambient light sensor 16. Forward ambient light sensor 16 may be any device operable to sense the intensity of ambient light in the direction it is oriented. Accordingly, forward ambient light sensor 16 is disposed such that it may detect forward ambient light 32 and is communicatively connected to controller 50. For example, forward ambient light sensor 16 may be located on a windshield 30, a headliner, or an interior rearview mirror 12a.

In other embodiments, the rearview image sensor 36 may be used to sense ambient light instead of using a separate forward ambient light sensor 16. An example of the use of a rearview image sensor to sense ambient light is disclosed in International PCT Application No. PCT/IB2024/062328, entitled “SYSTEM AND METHOD FOR ESTIMATING NATURAL DAYLIGHT USING AN IMAGE SENSOR” and filed on Dec. 6, 2024, the entire disclosure of which is incorporated herein by reference.

In some embodiments, rearview system 14 comprises a display 38. The display 38 may be any digital screen, such as, a light emitting diode (LED) display, organic LED display, liquid crystal display (LCD), etc. The display 38 may be communicatively connected to rearview image sensor 36 and operable to display a view of the exterior environment outside vehicle 10. For example, the display 38 may be configured to display image data captured by rearview image sensor 36 to depict rearward scene 28 such that a user 22 may view rearward scene 28 in vehicle 10 without turning around.

In some embodiments, the rearview image sensor 36 may be associated with the inside rearview mirror assembly 12a as shown in FIG. 4. Referring to FIGS. 2 and 4, the rearview mirror assembly 12a may include a mirror element 43 that may be an electro-optic mirror element 44a disposed to provide a driver of the vehicle with a view rearward relative to the vehicle. The electro-optic mirror element 44a has variable reflectivity. The electro-optic element 44a (and elements 44b and 44c) may comprise an electrochromic (EC) mirror element or a liquid crystal mirror element. In this configuration, the electro-optic element 44a may vary in reflectivity in response to a control signal from the controller 50. The control signal may change an electrical potential supplied to the electro-optic element 44a to control the reflectivity. The controller 50 selects the electrical potential to supply to the electro-optic element 44a based at least in part on a determined amount of ambient light and the detection of light sources 102 in images 100 within a region corresponding to the field of view reflected by that mirror element to the driver's eyes.

When implemented as part of the inside rearview mirror assembly 12a, the image sensor 36 may be disposed in the bezel adjacent the electro-optic mirror element 44a or proximate a rear surface of the electro-optic assembly.

If the image sensor 36 is located at the rear of the vehicle 10, it may also function as a back-up assist camera or a full-time display mirror (FDM) camera.

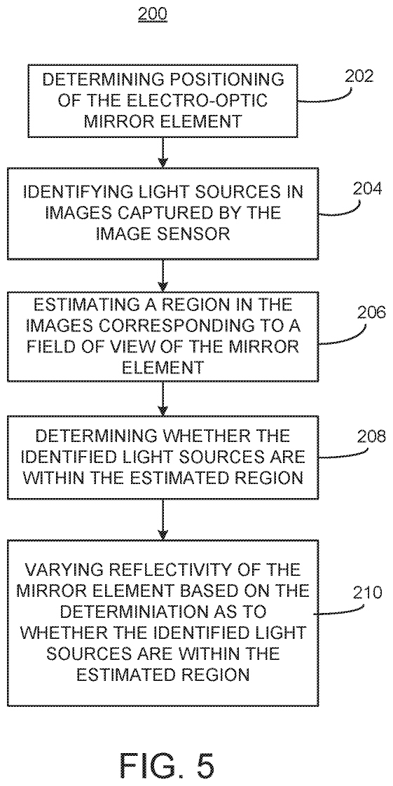

A method 200 of varying reflectance of an electro-optic mirror of a vehicle is illustrated in the flowchart of FIG. 5. The electro-optic mirror provides a first field of view to the driver of the vehicle. This method 200 may be performed by the controller 50 or other structures. The method 200 includes the steps of: determining positioning of the electro-optic mirror element (step 202); identifying one or more light sources in one or more images captured by an image sensor (step 204); estimating a region in the one or more images corresponding to the first field of view (step 206); determining whether the identified one or more light sources are within the estimated region (step 208); and varying the reflectivity of the electro-optic mirror element based, at least in part, on the determination as to whether the identified one or more light sources are within the estimated region (step 210).

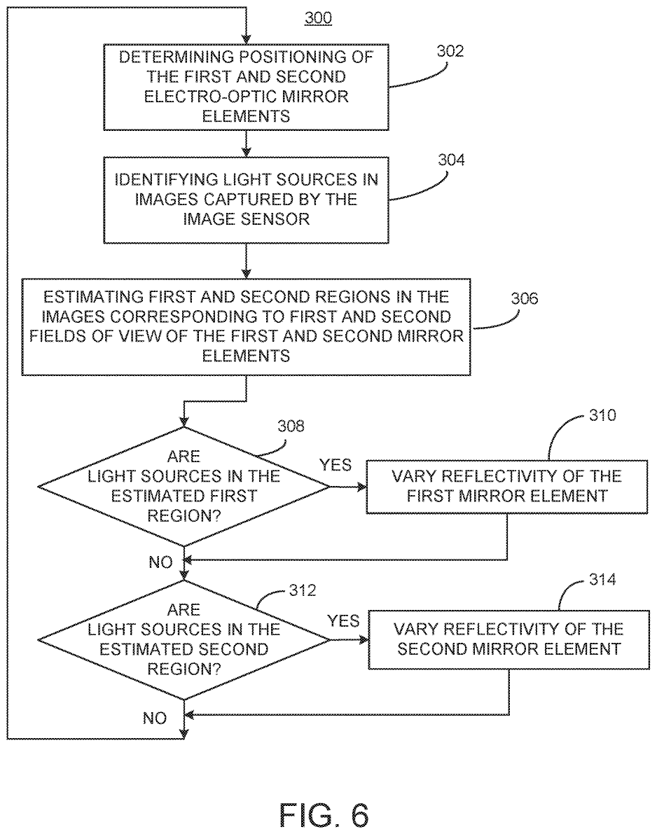

In a scenario where the rearview system 14 includes the inside rearview mirror assembly 12a having the first electro-optic mirror element 44a and the driver side outside rearview mirror assembly 12b having the second electro-optic mirror element 44b, a method 300 is provided for varying reflectance of the electro-optic mirror elements and is illustrated in the flowchart of FIG. 6. The first electro-optic mirror element 44a provides a first field of view to the driver of the vehicle and the second electro-optic mirror element 44b provides a second field of view. This method 300 may be performed by the controller 50 or other structures. The method 300 includes the steps of: determining positioning of the first and second electro-optic mirror elements (step 302); identifying one or more light sources in one or more images captured by an image sensor (step 304); estimating first and second regions in the one or more images corresponding to the respective first and second fields of view (step 306); determining whether the identified one or more light sources are within the estimated first region (step 308); varying the reflectivity of the first electro-optic mirror element based, at least in part, on the determination as to whether the identified one or more light sources are within the estimated first region (step 310); determining whether the identified one or more light sources are within the estimated second region (step 312); and varying the reflectivity of the second electro-optic mirror element based, at least in part, on the determination as to whether the identified one or more light sources are within the estimated second region (step 314). The process is then repeated to detect movement of the mirror elements and to continue to identify light sources and their relative positions.

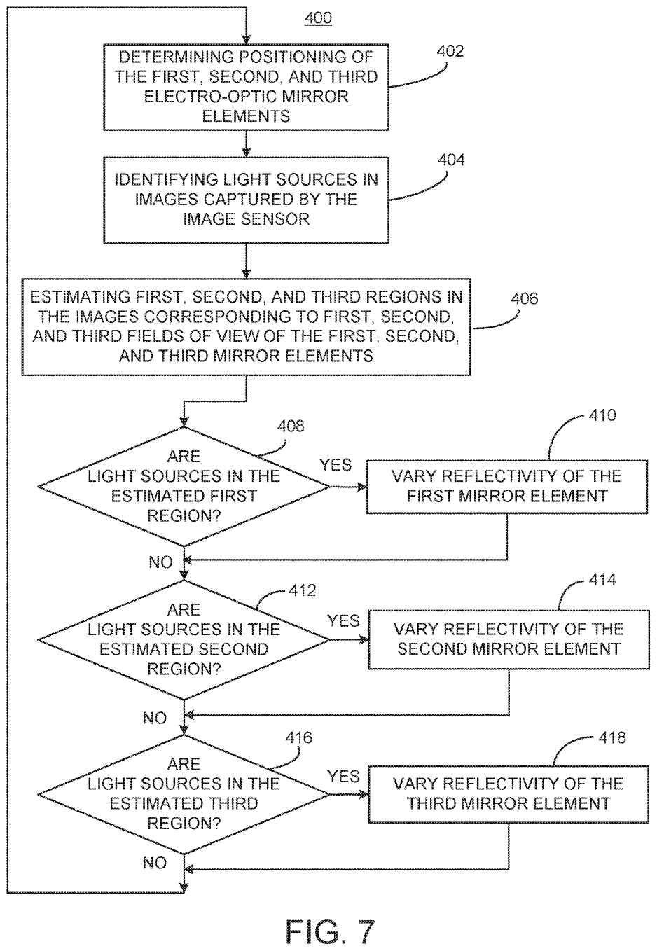

In a scenario where the rearview system 14 includes the inside rearview mirror assembly 12a having the first electro-optic mirror element 44a, the driver side outside rearview mirror assembly 12b having the second electro-optic mirror element 44b, and the passenger side outside rearview mirror assembly 12c having the third electro-optic mirror element 44c, a method 400 is provided for varying reflectance of the electro-optic mirror elements and is illustrated in the flowchart of FIG. 7. The first electro-optic mirror element 44a provides a first field of view to the driver of the vehicle, the second electro-optic mirror element 44b provides a second field of view, and the third electro-optic mirror element 44c provides a third field of view. This method 400 may be performed by the controller 50 or other structures. The method 400 includes the steps of: determining positioning of the first, second, and third electro-optic mirror elements (step 402); identifying one or more light sources in one or more images captured by an image sensor (step 404); estimating first, second, and third regions in the one or more images corresponding to the respective first, second, and third fields of view (step 406); determining whether the identified one or more light sources are within the estimated first region (step 408); varying the reflectivity of the first electro-optic mirror element based, at least in part, on the determination as to whether the identified one or more light sources are within the estimated first region (step 410); determining whether the identified one or more light sources are within the estimated second region (step 412); varying the reflectivity of the second electro-optic mirror element based, at least in part, on the determination as to whether the identified one or more light sources are within the estimated second region (step 414); determining whether the identified one or more light sources are within the estimated third region (step 416); and varying the reflectivity of the third electro-optic mirror element based, at least in part, on the determination as to whether the identified one or more light sources are within the estimated third region (step 418). The process is then repeated to detect movement of the mirror elements and to continue to identify light sources and their relative positions.

As noted above, the image sensor 36 may be part of a driver identification and/or monitoring system 15, which is described further below. The system 15 may be operable to perform an identification function. In an exemplary embodiment, the driver identification and/or monitoring system 15 may be incorporated in the inside rearview mirror assembly 12a as shown in FIG. 4.

The driver identification and/or monitoring system 15 may be configured to process and/or control an identification function. The identification function may comprise an eye-scan or retinal identification function or facial recognition. In this configuration, the driver identification and/or monitoring system 15 may provide for the interior rearview mirror assembly 12a to be configured to identify an operator or passenger of a vehicle based on the eye-scan or facial recognition identification functions. The identification function may be processed by the controller and/or communicated from the controller to one or more vehicle systems to provide for an identification of the operator 22 or passenger of the vehicle 10.

The eye-scan-identification function may utilize an infrared illumination of an iris of an eye for the identification. The illumination of the eye(s) may be optimized in conditions allowing for a high optical transmittance in the near infrared (NIR) range. Accordingly, the disclosure provides for a mirror element that may have a high light transmittance in wavelengths ranging from about 800 nm to 1000 nm in the optical spectrum. Additionally, in some implementations, the rearview mirror assembly 12a may comprise a plurality of light sources 18 configured to illuminate at least one iris of the operator of the vehicle.

The image sensor 36 may be configured to be able to detect light projected from at least one light source 18 that reflects back from the illuminated scene. The at least one light source 18 may correspond to one or more infrared emitters configured to output an emission 20 of light in the NIR range. In this configuration, the controller 50 may be configured to selectively activate the one or more infrared emitters corresponding to the at least one light source 18 to illuminate the iris, such that an identity of an operator (driver) 22 of the vehicle may be determined.

The driver identification and/or monitoring system 15 may further be used for driver and/or cabin monitoring purposes as a driver monitoring system (DMS). Such a DMS may detect whether the driver 22 appears drowsy or falls asleep while driving the vehicle. The DMS may also monitor for inattentiveness and other driver states. In addition, the DMS may monitor the presence/absence of a driver.

The infrared emitters or the light sources 18 may correspond to a plurality of infrared emitter banks. Each of the infrared emitter banks may comprise a plurality of light emitting diodes, which may be grouped in a matrix or otherwise grouped and disposed behind a rear surface of the electro-optic device. In an exemplary embodiment, the plurality of light sources 18 may correspond to a first emitter bank 24 and a second emitter bank 26. The first emitter bank 24 may be configured to output the emission in the NIR range from a first side portion 29 of a front surface 31 of the mirror element 44a. The second emitter bank 26 may be configured to output the emission in the NIR range from a second side portion 33 of the front surface 31 of the mirror element 43, which may comprise an electro-optic mirror element 44a. In this configuration, the monitoring apparatus 15 may be configured to illuminate the eyes of the operator 22, such that the image sensor 36 may capture an image of the irises of the eyes.

The image sensor 36 may be disposed on a circuit board 37, for example, a printed circuit board in communication with the controller 50. The controller 50 may further be in communication with various devices that may be incorporated in the vehicle 10 via the communication bus 60 or any other suitable communication interface 54. The controller 50 may be directly connected to the outside mirror elements 44b,44c or may be in communication over the bus 60. The controller 50 may correspond to one or more processors or circuits, which may be configured to process image data received from the image sensor 36. In this configuration, the image data may be communicated from the image sensor 36 to the controller 50. The controller 50 may process the image data with one or more algorithms configured to determine the identity of the operator of the vehicle.

The controller 50 may further be in communication with the display 38. The display 38 may be disposed in the mirror assembly 12a behind the rear surface. The controller 50 may be operable to display the image data received from the image sensor 36, such that the operator 22 may view the image data. In this configuration, the operator 22 may adjust a position of the eyes shown on the display 38 to position the eyes such that the image data may include the necessary features required to identify the operator. In an exemplary embodiment, the features required to identify the operator of the vehicle may correspond to features of the eyes of the operator 22 (e.g., the irises).

The display 38 may correspond to a partial or a full display mirror configured to display an image data through at least a portion of the mirror assembly 12a. The display 38 may be constructed utilizing various technologies, for example LCD, LED, OLED, plasma, DLP or other display technology. Examples of display assemblies that may be utilized with the present disclosure may include U.S. Pat. No. 6,572,233 entitled “REARVIEW MIRROR WITH DISPLAY,” U.S. Pat. No. 8,237,909 entitled “VEHICULAR REARVIEW MIRROR ASSEMBLY INCLUDING INTEGRATED BACKLIGHTING FOR A LIQUID CRYSTAL DISPLAY (LCD),” U.S. Pat. No. 8,411,245 entitled “MULTI-DISPLAY MIRROR SYSTEM AND METHOD FOR EXPANDED VIEW AROUND A VEHICLE,” and U.S. Pat. No. 8,339,526 entitled “VEHICLE REARVIEW MIRROR ASSEMBLY INCLUDING A HIGH INTENSITY DISPLAY,” which are incorporated herein by reference in their entirety.

The driver identification and/or monitoring system 15 may further comprise an indicator 40 in the mirror assembly 12a. The indicator 40 may be in communication with the controller and configured to output a signal to identify a state of the eye scanning operation and/or the rearview image sensor 36. The indicator 40 may correspond to a light source that may be operable to flash and/or change colors to communicate a state of the monitoring system 15. The indicator 40 may correspond to a light emitting diode (LED), and in an exemplary embodiment, the indicator 40 may correspond to a red, green, and blue (RGB) LED operable to identify the state of the driver identification and/or monitoring system 15 by outputting one of more colored emissions of light.

Variable reflectance mirror assemblies 12 may be implemented using a variety of electro-optic mirror elements 44a,44b,44c, such as those described in U.S. Pat. No. 3,680,951 entitled “PHOTOELECTRICALLY-CONTROLLED REAR-VIEW MIRROR” to Jordan et al., and U.S. Pat. No. 4,443,057 entitled “AUTOMATIC REARVIEW MIRROR FOR AUTOMOTIVE VEHICLES” to Bauer et al., each of which is incorporated herein by reference. Variable reflectance mirror assemblies 12 may be formed using liquid crystal cells as is described in U.S. Pat. No. 4,632,509 entitled “GLARE-SHIELDING TYPE REFLECTOR” to Ohmi et al., which is incorporated herein by reference. In an exemplary embodiment, variable reflectance mirror assemblies 12 may each be implemented as an electrochromic cell, which varies its reflectance in response to an applied control voltage, such as is described in U.S. Pat. No. 4,902,108 entitled “SINGLE-COMPARTMENT, SELF-ERASING, SOLUTION PHASE ELECTROCHROMIC DEVICES, SOLUTIONS FOR USE THEREIN, AND USES THEREOF” to Byker, which is incorporated herein by reference. Electrochromic elements include an electrochromic medium having at least one solvent, at least one anodic material, and at least one cathodic material. Both of the anodic and cathodic materials are electroactive and at least one of them is electrochromic. It will be understood that regardless of its ordinary meaning, the term “electroactive” will be defined herein as a material that undergoes a modification in its oxidation state upon exposure to a particular electrical potential difference. Additionally, it will be understood that the term “electrochromic” will be defined herein, regardless of its ordinary meaning, as a material that exhibits a change in its extinction coefficient at one or more wavelengths upon exposure to a particular electrical potential difference. Electrochromic components, as described herein, include materials whose color or opacity are affected by electric current, such that when an electrical current is applied to the material, the color or opacity changes from a first phase to a second phase. The electrochromic component may be a single-layer, single-phase component, multi-layer component, or multi-phase component, as described in U.S. Pat. No. 5,928,572 entitled “ELECTROCHROMIC LAYER AND DEVICES COMPRISING SAME,” U.S. Pat. No. 5,998,617 entitled “ELECTROCHROMIC COMPOUNDS,” U.S. Pat. No. 6,020,987 entitled “ELECTROCHROMIC MEDIUM CAPABLE OF PRODUCING A PRE-SELECTED COLOR,” U.S. Pat. No. 6,037,471 entitled “ELECTROCHROMIC COMPOUNDS,” U.S. Pat. No. 6,141,137 entitled “ELECTROCHROMIC MEDIA FOR PRODUCING A PRE-SELECTED COLOR,” U.S. Pat. No. 6,241,916 entitled “ELECTROCHROMIC SYSTEM,” U.S. Pat. No. 6,193,912 entitled “NEAR INFRARED-ABSORBING ELECTROCHROMIC COMPOUNDS AND DEVICES COMPRISING SAME,” U.S. Pat. No. 6,249,369 entitled “COUPLED ELECTROCHROMIC COMPOUNDS WITH PHOTOSTABLE DICATION OXIDATION STATES,” U.S. Pat. No. 6,137,620 entitled “ELECTROCHROMIC MEDIA WITH CONCENTRATION ENHANCED STABILITY, PROCESS FOR THE PREPARATION THEREOF AND USE IN ELECTROCHROMIC DEVICES,” U.S. Pat. No. 6,519,072, entitled “ELECTROCHROMIC DEVICE,” and International Patent Application Serial Nos. PCT/US98/05570 entitled “ELECTROCHROMIC POLYMERIC SOLID FILMS, MANUFACTURING ELECTROCHROMIC DEVICES USING SUCH SOLID FILMS, AND PROCESSES FOR MAKING SUCH SOLID FILMS AND DEVICES,”PCT/EP98/03862 entitled “ELECTROCHROMIC POLYMER SYSTEM,” and PCT/US98/05570 entitled “ELECTROCHROMIC POLYMERIC SOLID FILMS, MANUFACTURING ELECTROCHROMIC DEVICES USING SUCH SOLID FILMS, AND PROCESSES FOR MAKING SUCH SOLID FILMS AND DEVICES,” which are herein incorporated by reference in their entirety. Though specific structures are disclosed for variable reflectance mirror assemblies 12, many other electrochromic devices may be used to implement variable reflectance mirror assemblies 12 without departing from the spirit of the disclosure.

Although the above embodiments pertain to rearview mirror assemblies, the concepts described herein may more generally be applied to any dimmable optical element of a vehicle, such as visors, windows, and the afore-mentioned rearview mirror assemblies. Stated another way, the general concept is dynamically mapping a user's field of view through a dimmable element onto the field of view onto the image sensor to determine when dimming of the element is needed for an identified glare source. This mapping may be based on head position and the position of the dimmable element. For example, with a visor or a forward window of a vehicle, the image sensor 36 would have a forward field of view instead of a rearward field of view as with a rearview mirror assembly. An example of a dimmable visor is disclosed in commonly-assigned U.S. Patent Application Publication No. US 2024/0227515 A9 filed on Oct. 24, 2023, by Adam R. Heintzelman et al. and entitled “SWITCHABLE VANITY MIRROR IN ELECTROCHROMIC SUN VISOR,” the entire disclosure of which is incorporated herein by reference.

With respect to this more general application of the disclosed concepts, a dimmable optical element is provided for a vehicle. The dimmable optical element comprises: an electro-optic element disposed to provide a driver of the vehicle with a first field of view, the electro-optic element having variable dimming; an image sensor associated with the vehicle to capture images of a scene within a second field of view; and a controller communicatively connected to the electro-optic element and the image sensor. The controller configured to: identify one or more light sources in one or more images captured by the image sensor; determine the position of the driver; estimate a region in the one or more images corresponding to the first field of view based, at least in part, on the position of the driver; determine whether the identified one or more light sources are within the estimated region; and vary the dimming of the electro-optic element based, at least in part, on the determination as to whether the identified one or more light sources are within the estimated region.

According to various aspects, the disclosure may implement one or more of the following features or configurations in various combinations with the general application of the disclosed concepts described in the preceding paragraph:
a. wherein the dimmable optical element is one of a rearview mirror, a visor, and a window;
b. wherein the second field of view is forward of the vehicle and the dimmable optical element is a visor;

C. wherein the second field of view is rearward of the vehicle and the dimmable optical element is a rearview mirror;
d. wherein the controller determines the position of the driver by any one or more of the driver's seat position, in-cabin sensing, or assumptions based on nominal conditions;
e. wherein the controller determines the position of the image sensor and estimates the region of the one or more images based, at least in part, on the position of the image sensor;
f. wherein the controller determines the position of the electro-optic element from input from the position sensor; and
g. wherein the position and/or orientation of the electro-optic element may be determined based on various sensors, cameras, memories, etc.

It is another aspect of the present disclosure to provide a dimmable optical element for a vehicle. The dimmable optical element comprises: an electro-optic element disposed to provide a driver of the vehicle with a first field of view, the electro-optic element having variable dimming; an image sensor associated with the vehicle to capture images of a scene within a second field of view; a position sensor configured to sense positioning of the electro-optic element; and a controller communicatively connected to the electro-optic element, the image sensor, and the position sensor. The controller configured to: determine positioning of the electro-optic element; identify one or more light sources in one or more images captured by the image sensor; estimate a region in the one or more images corresponding to the first field of view based, at least in part, on the position of the electro-optic element; determine whether the identified one or more light sources are within the estimated region; and vary the dimming of the electro-optic element based, at least in part, on the determination as to whether the identified one or more light sources are within the estimated region.

According to various aspects, the disclosure may implement one or more of the following features or configurations:
a. wherein the dimmable optical element is one of a rearview mirror, a visor, and a window;
b. wherein the second field of view is forward of the vehicle and the dimmable optical element is a visor;
c. wherein the second field of view is rearward of the vehicle and the dimmable optical element is a rearview mirror;
d. wherein the controller determines the position of the driver by any one or more of the driver's seat position, in-cabin sensing, or assumptions based on nominal conditions, and wherein the controller estimates the region in the one or more images corresponding to the first field of view based, at least in part, on the position of the driver;
e. wherein the controller determines the position of the electro-optic element from input from the position sensor; and
f. wherein the position and/or orientation of the electro-optic element may be determined based on various sensors, cameras, memories, etc.

It is one aspect of the present disclosure to provide a rearview mirror assembly for a vehicle, the rearview mirror assembly comprising: an electro-optic mirror element disposed to provide a driver of the vehicle with a first field of view rearward relative to the vehicle, the electro-optic mirror element having variable reflectivity; an image sensor associated with the vehicle to capture images of a rearward scene within a second field of view; a position sensor configured to sense positioning of the electro-optic mirror element; and a controller communicatively connected to the electro-optic mirror element, the image sensor, and the position sensor. The controller is configured to: determine positioning of the electro-optic mirror element; identify one or more light sources in one or more images captured by the image sensor; estimate a region in the one or more images corresponding to the first field of view; determine whether the identified one or more light sources are within the estimated region; and vary the reflectivity of the electro-optic mirror element based, at least in part, on the determination as to whether the identified one or more light sources are within the estimated region.

According to various aspects, the disclosure may implement one or more of the following features or configurations in various combinations:
a. wherein the electro-optic mirror element comprises an active-matrix electrode such that portions of the electro-optic mirror element may be individually controlled to have variable reflectivity, wherein the controller maps the corresponding locations of the positions of the electro-optic mirror element to the region of the one or more images and determines within which locations the identified one or more light sources are identified and varies the reflectivity of those portions of the electro-optic mirror element corresponding to the determined locations;
b. wherein the controller determines the position of the driver and estimates the region of the one or more images based, at least in part, on the position of the driver;
c. wherein the controller determines the position of the driver by any one or more of the driver's seat position, in-cabin sensing, or assumptions based on nominal conditions;
d. wherein the controller determines the position of the image sensor and estimates the region of the one or more images based, at least in part, on the position of the image sensor; and
e. wherein the controller determines the position of the electro-optic mirror element from input from the position sensor.

According to another aspect of the invention, a driver monitoring system is provided comprising the rearview mirror assembly of any one of the above aspects including the image sensor and the controller, wherein the controller is further configured to monitor and/or identify the driver based on images received from the image sensor.

According to another aspect of the invention, a rearview mirror system is provided for a vehicle, the rearview mirror system comprising: an interior rearview mirror assembly comprising: a first electro-optic mirror element; at least one outside rearview mirror assembly; an image sensor; and a controller. The interior rearview mirror assembly comprising: a first electro-optic mirror element disposed to provide a driver of the vehicle with a first field of view rearward relative to the vehicle, the first electro-optic mirror element having variable reflectivity; and a first position sensor configured to sense positioning of the first electro-optic mirror element. The at least one outside rearview mirror assembly comprising: a second electro-optic mirror element disposed to provide the driver of the vehicle with a second field of view rearward relative to the vehicle, the second electro-optic mirror element having variable reflectivity; and a second position sensor configured to sense positioning of the second electro-optic mirror element. The image sensor is associated with the vehicle to capture images of a rearward scene within a third field of view. The controller is communicatively connected to the first and second electro-optic mirror elements, the image sensor, and the first and second position sensors, the controller configured to: determine positioning of the first and second electro-optic mirror elements; identify one or more light sources in one or more images captured by the image sensor; estimate a first region in the one or more images corresponding to the first field of view; estimate a second region in the one or more images corresponding to the second field of view; determine whether the identified one or more light sources are within the estimated first region in the one or more images; vary the reflectivity of the first electro-optic mirror element based, at least in part, on the determination as to whether the identified one or more light sources are within the estimated first region in the one or more images; determine whether the identified one or more light sources are within the estimated second region in the one or more images; and vary the reflectivity of the second electro-optic mirror element based, at least in part, on the determination as to whether the identified one or more light sources are within the estimated second region in the one or more images.

According to various aspects, the disclosure may implement one or more of the following features or configurations in various combinations:
a. wherein the controller determines the position of the driver and estimates the first and second regions of the one or more images based, at least in part, on the position of the driver;
b. wherein the controller determines the position of the image sensor and estimates the first and second regions of the one or more images based, at least in part, on the position of the image sensor;
c. wherein the at least one outside rearview mirror assembly comprises a driver side outside rearview mirror assembly and a passenger side outside rearview mirror assembly, the driver side outside rearview mirror assembly comprising the second electro-optic mirror element and the second position sensor;
d. wherein the passenger side outside rearview mirror assembly comprises a third electro-optic mirror element disposed to provide the driver of the vehicle with a third field of view rearward relative to the vehicle, the third electro-optic mirror element having variable reflectivity; and a third position sensor configured to sense positioning of the third electro-optic mirror element; and
e. wherein the controller is communicatively connected to the third electro-optic mirror element and the third position sensor and is further configured to:
   i. determine positioning of the third electro-optic mirror element;
ii. estimate a third region in the one or more images corresponding to the third field of view;
   iii. determine whether the identified one or more light sources are within the estimated third region in the one or more images; and
   iv. vary the reflectivity of the third electro-optic mirror element based, at least in part, on the determination as to whether the identified one or more light sources are within the estimated third region in the one or more images.

According to another aspect of the invention, a method is provided for varying reflectance of an electro-optic mirror of a vehicle using a controller and an image sensor, the electro-optic mirror provides a first field of view to the driver of the vehicle. The method includes the steps of: determining positioning of the electro-optic mirror; identifying one or more light sources in one or more images captured by the image sensor; estimating a region in the one or more images corresponding to the first field of view; determining whether the identified one or more light sources are within the estimated region; and varying the reflectivity of the electro-optic mirror based, at least in part, on the determination as to whether the identified one or more light sources are within the estimated region.

According to various aspects, the disclosure may implement one or more of the following features or configurations in various combinations:
a. wherein the region in the one or more images corresponding to the first field of view is estimated based on the positioning of the electro-optic mirror;
b. wherein the vehicle includes a second electro-optic mirror providing a second field of view to the driver of the vehicle, the method further comprising:
   i. determining positioning of the second electro-optic mirror;
ii. estimating a second region in the one or more images corresponding to the second field of view based, at least in part, on the positioning of the second electro-optic mirror;
   iii. determining whether the identified one or more light sources are within the estimated second region; and
   iv. varying the reflectivity of the second electro-optic mirror based, at least in part, on the determination as to whether the identified one or more light sources are within the estimated second region; and
c. wherein the vehicle includes a third electro-optic mirror providing a third field of view to the driver of the vehicle, the method further comprising:
   i. determining positioning of the third electro-optic mirror;
   ii. estimating a third region in the one or more images corresponding to the third field of view based, at least in part, on the positioning of the third electro-optic mirror;
   iii. determining whether the identified one or more light sources are within the estimated third region; and
   iv. varying the reflectivity of the third electro-optic mirror based, at least in part, on the determination as to whether the identified one or more light sources are within the estimated third region.

According to another aspect of the invention, a method is provided for varying reflectance of electro-optic mirrors of a rearview system including an inside rearview mirror assembly having a first electro-optic mirror providing a first field of view to a driver of the vehicle and a driver side outside rearview mirror assembly having a second electro-optic mirror providing a second field of view to the driver, the method includes the steps of: determining positioning of the first and second electro-optic mirrors; identifying one or more light sources in one or more images captured by an image sensor; estimating first and second regions in the one or more images corresponding to the respective first and second fields of view; determining whether the identified one or more light sources are within the estimated first region; varying the reflectivity of the first electro-optic mirror based, at least in part, on the determination as to whether the identified one or more light sources are within the estimated first region; determining whether the identified one or more light sources are within the estimated second region; varying the reflectivity of the second electro-optic mirror based, at least in part, on the determination as to whether the identified one or more light sources are within the estimated second region. The process is then repeated to detect movement of the mirror elements and to continue to identify light sources and their relative positions.

According to another aspect of the invention, a method is provided for varying reflectance of electro-optic mirror elements of a rearview system including an inside rearview mirror assembly having a first electro-optic mirror element providing a first field of view to a driver of the vehicle, a driver side outside rearview mirror assembly having a second electro-optic mirror element providing a second field of view to the driver, and a passenger side outside rearview mirror assembly having a third electro-optic mirror element providing a third field of view to the driver, the method includes the steps of: determining positioning of the first, second, and third electro-optic mirror elements; identifying one or more light sources in one or more images captured by an image sensor; estimating first, second, and third regions in the one or more images corresponding to the respective first, second, and third fields of view; determining whether the identified one or more light sources are within the estimated first region; varying the reflectivity of the first electro-optic mirror element based, at least in part, on the determination as to whether the identified one or more light sources are within the estimated first region; determining whether the identified one or more light sources are within the estimated second region; varying the reflectivity of the second electro-optic mirror element based, at least in part, on the determination as to whether the identified one or more light sources are within the estimated second region; determining whether the identified one or more light sources are within the estimated third region; and varying the reflectivity of the third electro-optic mirror element based, at least in part, on the determination as to whether the identified one or more light sources are within the estimated third region. The process is then repeated to detect movement of the mirror elements and to continue to identify light sources and their relative positions.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above are merely for illustrative purposes and not intended to limit the scope of the device, which is defined by the following claims as interpreted according to the principles of patent law, including the Doctrine of Equivalents.

1. A rearview mirror assembly for a vehicle, the rearview mirror assembly comprising:
an electro-optic mirror element disposed to provide a driver of the vehicle with a first field of view rearward relative to the vehicle, the electro-optic mirror element having variable reflectivity;
an image sensor associated with the vehicle to capture images of a rearward scene within a second field of view;
a position sensor configured to sense positioning of the electro-optic mirror element; and a controller communicatively connected to the electro-optic mirror element, the image sensor, and the position sensor, the controller configured to:
determine positioning of the electro-optic mirror element;
identify one or more light sources in one or more images captured by the image sensor;
estimate a region in the one or more images corresponding to the first field of view;
determine whether the identified one or more light sources are within the estimated region; and
vary the reflectivity of the electro-optic mirror element based, at least in part, on the determination as to whether the identified one or more light sources are within the estimated region.

2. The rearview mirror assembly of claim 1, wherein the electro-optic mirror element comprises an active-matrix electrode such that portions of the electro-optic mirror element may be individually controlled to have variable reflectivity, wherein the controller maps the corresponding locations of the positions of the electro-optic mirror element to the region of the one or more images and determines within which locations the identified one or more light sources are identified and varies the reflectivity of those portions of the electro-optic mirror element corresponding to the determined locations.

3. The rearview mirror assembly of claim 1, wherein the controller determines the position of the driver and estimates the region of the one or more images based, at least in part, on the position of the driver.

4. The rearview mirror assembly of claim 1, wherein the controller determines the position of the driver by any one or more of the driver's seat position, in-cabin sensing, or assumptions based on nominal conditions.

5. The rearview mirror assembly of claim 1, wherein the controller determines the position of the image sensor and estimates the region of the one or more images based, at least in part, on the position of the image sensor.

6. The rearview mirror assembly of claim 1, wherein the controller determines the position of the electro-optic mirror element from input from the position sensor.

7. A driver monitoring system comprising:
the rearview mirror assembly of claim 1 including the image sensor and the controller, wherein the controller is further configured to monitor and/or identify the driver based on images received from the image sensor.

8. A rearview mirror system for a vehicle, the system comprising:
an interior rearview mirror assembly comprising:
a first electro-optic mirror element disposed to provide a driver of the vehicle with a first field of view rearward relative to the vehicle, the first electro-optic mirror element having variable reflectivity; and
a first position sensor configured to sense positioning of the first electro-optic mirror element;
at least one outside rearview mirror assembly comprising:
a second electro-optic mirror element disposed to provide the driver of the vehicle with a second field of view rearward relative to the vehicle, the second electro-optic mirror element having variable reflectivity; and
a second position sensor configured to sense positioning of the second electro-optic mirror element;
an image sensor associated with the vehicle to capture images of a rearward scene within a third field of view; and
a controller communicatively connected to the first and second electro-optic mirror elements, the image sensor, and the first and second position sensors, the controller configured to:
determine positioning of the first and second electro-optic mirror elements;
identify one or more light sources in one or more images captured by the image sensor;
estimate a first region in the one or more images corresponding to the first field of view;
estimate a second region in the one or more images corresponding to the second field of view;
determine whether the identified one or more light sources are within the estimated second region in the one or more images;
vary the reflectivity of the first electro-optic mirror element based, at least in part, on the determination as to whether the identified one or more light sources are within the estimated first region in the one or more images;
determine whether the identified one or more light sources are within the estimated second region in the one or more images; and
vary the reflectivity of the second electro-optic mirror element based, at least in part, on the determination as to whether the identified one or more light sources are within the estimated second region in the one or more images.

9. The rearview mirror system of claim 8, wherein the controller determines the position of the driver and estimates the first and second regions of the one or more images based, at least in part, on the position of the driver.

10. The rearview mirror system of claim 8, wherein the controller determines the position of the image sensor and estimates the first and second regions of the one or more images based, at least in part, on the position of the image sensor.

11. The rearview mirror system of claim 8, wherein the at least one outside rearview mirror assembly comprises a driver side outside rearview mirror assembly and a passenger side outside rearview mirror assembly, the driver side outside rearview mirror assembly comprising the second electro-optic mirror element and the second position sensor,
wherein the passenger side outside rearview mirror assembly comprises:
a third electro-optic mirror element disposed to provide the driver of the vehicle with a third field of view rearward relative to the vehicle, the third electro-optic mirror element having variable reflectivity; and
a third position sensor configured to sense positioning of the third electro-optic mirror element,
wherein the controller is communicatively connected to the third electro-optic mirror element and the third position sensor and is further configured to:
determine positioning of the third electro-optic mirror element;
estimate a third region in the one or more images corresponding to the third field of view;
determine whether the identified one or more light sources are within the estimated third region in the one or more images; and
vary the reflectivity of the third electro-optic mirror element based, at least in part, on the determination as to whether the identified one or more light sources are within the estimated third region in the one or more images.

12. A method for varying reflectance of an electro-optic mirror of a vehicle using a controller and an image sensor, the electro-optic mirror provides a first field of view to a driver of the vehicle, the method comprises the steps of:
determining positioning of the electro-optic mirror;
identifying one or more light sources in one or more images captured by the image sensor;
estimating a region in the one or more images corresponding to the first field of view;
determining whether the identified one or more light sources are within the estimated region; and
varying the reflectivity of the electro-optic mirror based, at least in part, on the determination as to whether the identified one or more light sources are within the estimated region.

13. The method of claim 12, wherein the region in the one or more images corresponding to the first field of view is estimated based on the positioning of the electro-optic mirror.

14. The method of any one of claim 12, wherein the vehicle includes a second electro-optic mirror providing a second field of view to the driver of the vehicle, the method further comprising:
determining positioning of the second electro-optic mirror;
estimating a second region in the one or more images corresponding to the second field of view based, at least in part, on the positioning of the second electro-optic mirror;
determining whether the identified one or more light sources are within the estimated second region; and
varying the reflectivity of the second electro-optic mirror based, at least in part, on the determination as to whether the identified one or more light sources are within the estimated second region.

15. The method of claim 14, wherein the vehicle includes a third electro-optic mirror providing a third field of view to the driver of the vehicle, the method further comprising:
determining positioning of the third electro-optic mirror;
estimating a third region in the one or more images corresponding to the third field of view based, at least in part, on the positioning of the third electro-optic mirror;
determining whether the identified one or more light sources are within the estimated third region; and
varying the reflectivity of the third electro-optic mirror based, at least in part, on the determination as to whether the identified one or more light sources are within the estimated third region.

16-29. (canceled)

30. The method of claim 12 and further including determining the position of the driver and estimating the region of the one or more images based, at least in part, on the position of the driver.

31. The method of claim 30, wherein the step of determining the position of the driver is by any one or more of the driver's seat position, in-cabin sensing, or assumptions based on nominal conditions.

32. The method of claim 12 and further including determining the position of the image sensor and estimates the region of the one or more images based, at least in part, on the position of the image sensor.

33. The method of claim 12, wherein the step of determining the position of the electro-optic mirror element includes receiving input from a position sensor.

34. The method of claim 14 and further including determining the position of the driver and estimates the first and second regions of the one or more images based, at least in part, on the position of the driver.
